(19) United States
(12) Patent Application Publication
(10) Pub. No.: US 2022/0105458 A1
(43) Pub. Date: Apr. 7, 2022

(54) FOLDABLE FILTER

(71) Applicant: Blueair AB, Stockholm (SE)

(72) Inventor: Jacob GUNNEFUR, Stockholm (SE)

(73) Assignee: Blueair AB, Stockholm (SE)

(21) Appl. No.: 17/427,704

(22) PCT Filed: Jan. 7, 2020
(86) PCT No.: PCT/EP2020/050175

§ 371 Date: Aug. 2, 2021

(30) Foreign Application Priority Data
Feb. 5, 2019 (EP) 19155548.1

(51) Int. Cl. B01D 46/52

(52) U.S. Cl. CPC B01D 46/523; B01D 2275/203; B01D 2273/14

(57) ABSTRACT

A foldable filter comprising a pleated section, said pleated section having a plurality of pleats and where said filter is in its operating configuration, each pleat has an operating width (W) from an air direction facing tip of one pleat to an air direction facing tip of the next pleat which is from 5 to 10% of a pleat amplitude (A), where said pleat amplitude is from 15 to 30 mm, and wherein said filter comprises an adhesive melt on a portion of the pleat tips to prevent those pleats extending substantially beyond said operating width (W) and wherein the means for preventing a portion of the pleats from extending beyond said operating width is adhesive fixed to a plurality of air direction facing tips. The invention also relates to an air purifier comprising such a foldable filter, as well as the foldable filter in a folded configuration and a packaged foldable filter comprising secondary packaging.

The present invention relates to improvements in filter technology for air purifiers.

WO 2015/090870 (Artemis Control) discloses a supplementary filter system for separating trace gases from air. Said filter system consists of frameless bellows made of filter material that is folded in a zigzag shape. The distance between folds and the position of the folds of the folded filter material are precisely defined by means of securing strips, and the bellows are compressible and expandable.

US 2016/263515 (Zhang Zhiquin) discloses air filters expandable from a collapsed arrangement to an expanded, end-use arrangement and to methods of making, using, and installing such air filters. Some embodiments relate to an air filter having an expanded state and a collapsed state. The air filter includes a filter media assembly including filter media including a plurality of pleats, first and second opposing sides, and first and second opposing ends. The air filter also includes a shape retention structure capable of being connected to at least a portion of the filter media assembly and capable of retention the filter media assembly in the expanded state. A spacing distance between adjacent pleats in the filter media is greater in the expanded state of the air filter than in the collapsed state of the air filter. In some embodiments, the air filter is an HVAC air filter.

WO 2016/032938 (3M Innovative Properties) discloses air filters. More particularly, it relates to air filters including pleated filter media that can be uniformly expanded and contracted. In some embodiments, the air filters are adjustably sized air filter systems. In some embodiments, the air filters can be used in a window opening.

Despite the prior art there is a need to provide low cost but effective filters for air purifiers of different shapes.

Accordingly, and in a first aspect, the present invention provides a foldable filter comprising a pleated section, said pleated section having a plurality of pleats and where said filter is in its operating configuration, each pleat has an operating width (W) from an air direction facing tip of one pleat to an air direction facing tip of the next pleat which is from 5 to 10% of a pleat amplitude (A), where said pleat amplitude is from 5 to 35 mm, and wherein said filter comprises an adhesive melt on a portion of the pleat tips to prevent those pleats extending substantially beyond said operating width (W).

The foldable filter according to the invention finds purpose in being more easily fitted to an air purifier of irregular or unusual shape. Traditional air purifiers have framed filters which are fixed in dimension and merely slotted into place. These filters are thus usually structurally planar and the frame is typically rigid. The rigid frame serves two purposes: firstly to provide a more suitable means for fixing the filter to the air purifier and keeping it in place; and second, to provide structural rigidity to the filter meaning that the filter is optimally configured for filtering the air passing through it.

Further, there is a need for filters to be frameless to save plastic usage.

The filter designer thus faces significant problems is developing a filter which is to be fitted to an irregular or unusually shaped purifier. This is in contrast to filters which are fitted to windows such as is described in the prior art where the shape is regular and the intention is to fill a space rather than to optimise purification performance.

The foldable filter of the invention is able to be used in such irregularly shaped or unusually shaped air purifiers while maintaining efficacious filtration. Such efficacious filtration is exhibited by maintaining a substantially constant pleat disposition in situ. Where the pleats have an average distance from the air direction facing tip of one pleat to the air direction facing tip of the next or neighbouring pleat of from 5 to 10% the pleat amplitude (A) the best performance is found.

By performance is meant the relationship between optimum filtration performance and air drop management. In air purification technology, reducing the pressure drop during filtration is the most important design challenge. This is in stark contrast to designers of HVAC (Heat Ventilation Air Conditioning) systems where the power source merely drives air through the filter no matter the design of the system or the filter. In air purifiers there is a distinct need for optimum energy management and so the best filtration for the lowest energy consumption, by way of fan speed management, is highly desirable.

The length of the pleat is the average distance from an imaginary line drawn between the air direction facing tips of neighbouring pleats to an imaginary line drawn between the tips on the opposite side of the pleat.

In a preferred embodiment the foldable filter is frameless. By frameless is meant that it comprises no rigid structural means which maintains its shape whether in use or not.

The foldable filter of the present invention is designed to be cheap to manufacture, package and ship between manufacture and sale and use. When required it can be unfolded into its operating configuration. This may be before applying to the air purifier or it may be unfolded when fitted into place in the air purifier.

Preferably, the foldable filter comprises a first and second end at opposite ends of the filter from one another and a means for attaching said first and second end to a cooperating means on an air purifying device or to the other of the first or second end. The filter may thus be fixed into operating configuration in many different ways. After unpacking, the filter may be fixed at a first end to the air purifier before being unfolded in situ. Such fixing may be by any suitable means for example a hook and eye, press stud, friction fit, etc. The fixing of the second end of the filter is thus the shape defining step. While it might be expected that the distance of the unfolding, i.e. the final distance between the first and second ends of the filter is the most important aspect when regarding the functional presentation of the pleats in fact the shape and presentation of the pleats is also affected by the filter touching the walls of the space that the filter is unfolded in. The second end is similarly fixed either to the air purifying device or to the first end of the filter.

The distance between the pleats is thus controlled by the means for preventing a portion of the pleats from extending beyond said operating width, which is fixed to a plurality of the tips of the pleats. Preferably, said means is disposed on an air direction facing side. In other words, the side of the pleats which faces the air coming into the filter as opposed to the direction which faces the air exiting the filter.

The filter comprises a plurality of pleats which enable the filter to be folded into a smaller space. The pleats comprise a series of external peaks and internal troughs and of course can be viewed as peaks and troughs from both faces.

Preferably, the means for preventing a portion of the pleats from extending beyond said operating width is a strap connected to a plurality of air direction facing tips. Preferably, the strap is foldable but sufficiently inelastic that it prevents the filter from being overextended. The strap is fixed to neighbouring peak tips such that the distance between the points of fixing on the strap is substantially equivalent to the operating configuration of each pleat.

Preferably, the means for preventing a portion of the pleats from extending beyond said operating width is attached to substantially all pleats.

In an alternatively preferred embodiment the means for preventing a portion of the pleats from extending beyond said operating width is adhesive fixed to a plurality of air direction facing tips.

In a second aspect there is provided an air purifier comprising a foldable filter according to the first aspect.

Preferably, the air purifier comprising a housing, a motor which is operated by a power source, an air displacement means, an air inlet and an air outlet and a removable and foldable filter according to the first aspect.

Preferably, the air purifier comprises a non-linear chamber in which the filter is maintained when in an operating configuration. More preferably, the chamber has a curved section and most preferably the curved chamber is substantially circular. When the filter is disposed in an operating configuration in the substantially non-linear chamber it is disposed such that the first and second free ends are facing each other.

In a preferred embodiment the air purifier comprises means for attaching the filter in place such as a lug, loop or Velcro®. The filter will comprise a cooperating attachment means such that the filter can be maintained in an operating configuration during use.

For example, the first end of the filter preferably comprises an attachment means which cooperates with an attachment means in the chamber of the air purifier. The filter is then unfolded in the air purifier by pulling the second free end away from the first free end. The second free end is then also attached to an attachment means in the chamber to maintain it in an operating configuration. This operating configuration maintains a defined distance between the pleats which is optimal for air purification.

In a preferred embodiment the second free end of the filter is attached to the first free end rather than the air purifier itself.

In a third aspect there is provided a foldable filter according to the first aspect in a folded configuration. The filter is folded when stored for sale or transport and typically the pleats are compressed such that the distance between the tips of neighbouring pleats is minimised.

In a fourth aspect there is provided a packaged foldable filter according to the third aspect and comprising secondary packaging. To maintain the folded filter in a folded configuration the filter is packaged in secondary packaging. Such secondary packaging includes shrink wrap as well as paper, card or other such packaging commonly used.

Embodiments of the invention will now be described with reference to the following non-limiting drawings in which

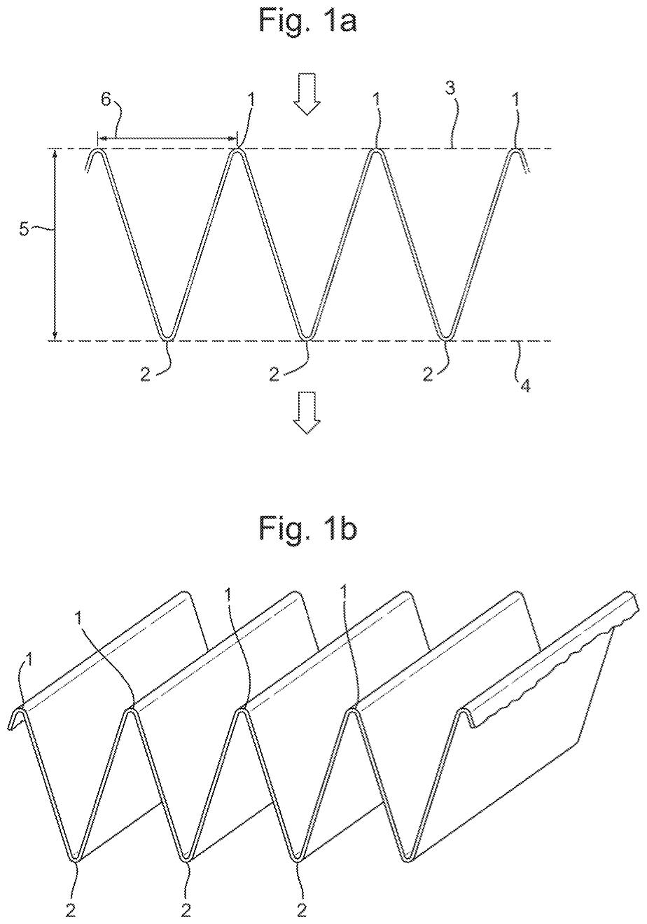

FIGS. 1a and 1b show a filter in schematic and in perspective view,

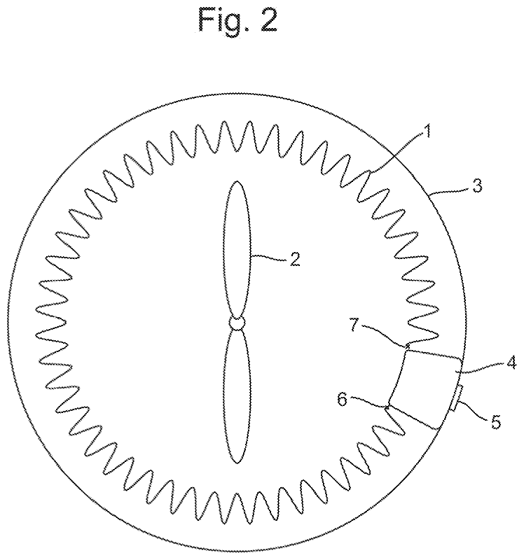

FIG. 2 is a plan view of a filter in an air purifier,

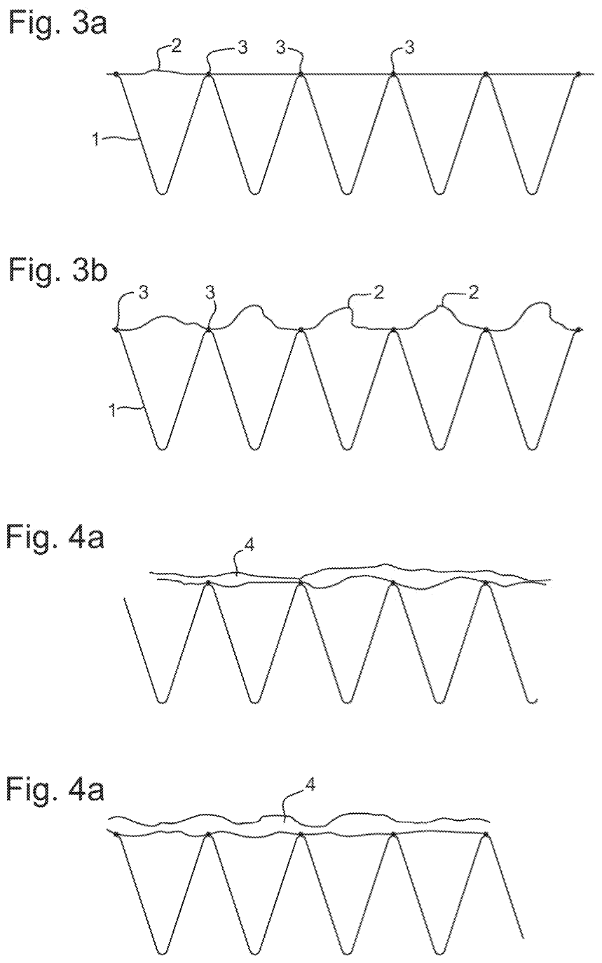

FIGS. 3a and 3b are a schematic showing how the filter pleats are held in an operating configuration,

FIGS. 4a and 4b are a similar schematic for an alternative embodiment,

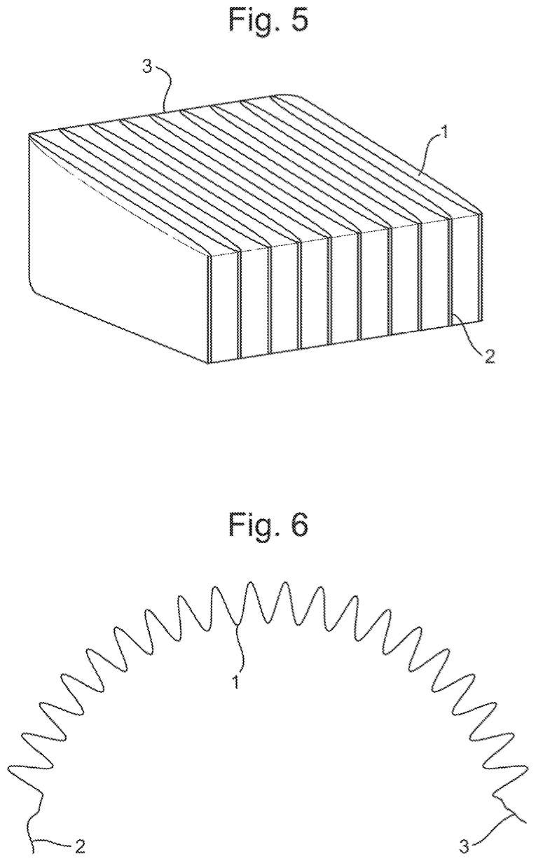

FIG. 5 shows a folded and packaged filter and FIG. 6 shows an unfolded filter and the means for attaching to a device.

FIG. 1a is a schematic representation of the pleat structure to show the relationship between the pleat tips and the air direction.

The air direction is shown by the arrows and the ambient air is forced through the pleated filter and purified as a result.

The pleat contains a series of opposing tips, the first set of tips (1) face the air flow while those on the opposite side (2) face the opposite direction.

The imaginary line (3) linking the air direction facing tips (1) is shown as is the imaginary line (4) linking the opposite tips (2). The distance between them is shown by distance (5). Similarly, the distance between neighbouring tips is also shown (6).

FIG. 1b is the same filter in perspective view.

FIG. 2 shows a filter (1) disposed in a circular configuration in an air purifier (3). The filter has a fan (2) which drives air through the device.

The filter (1) is connected to an operating module (4) by means of attachment means (6 and 7). The operating module (4) has an operating knob (5).

FIGS. 3a and 3b show a filter in an unfolded (3a) and folded (3b) configuration.

In 3a the filter is maintained in an operating configuration by a strap (2) which is fixed to the filter (1) at the pleat tips (3). The strap (2) is unable to stretch beyond that which is required to maintain an operating width between the adjacent tips (3).

In 3b the same filter is folded and the strap (2) is in a relaxed, un-stretched state as the pleat tips (3) are closer together.

In FIGS. 4a and 4a the tips distances are controlled by an adhesive (4) which is sufficiently resilient that the tips are maintained apart no more than a working distance when in operating configuration (4a) and yet can be squashed together when in a folded configuration (4b).

In FIG. 5 the filter (1) is folded and maintained in secondary packaging in the form of shrink fit packaging (3).

In FIG. 6 are shown the filter (1) and a pair of attachment means (2) and (3) on the opposing ends of the filter. These ends are used to attach to the air purifier to help maintain the filter in a stretched configuration during operation.

1. A foldable filter comprising a pleated section, said pleated section having a plurality of pleats and where said filter is in its operating configuration, each pleat has an operating width (W) from an air direction facing tip of one pleat to an air direction facing tip of the next pleat which is from 5 to 10% of a pleat amplitude (A), where said pleat amplitude is from 5 to 35 mm, and wherein said filter comprises an adhesive melt on a portion of the pleat tips to prevent those pleats extending substantially beyond said operating width (W) and wherein the means for preventing a portion of the pleats from extending beyond said operating width is adhesive fixed to a plurality of air direction facing tips.

2. The foldable filter according to claim 1 which is frameless.

3. The foldable filter according to claim 1, comprising a first and second end at opposite ends of the filter from one another and a means for attaching said first and second end to a cooperating means on an air purifying device or to the other of the first or second end.

4. The foldable filter according to claim 1 wherein the means for preventing a portion of the pleats from extending beyond said operating width is a strap connected to a plurality of air direction facing tips.

5. The foldable filter according to claim 1 in a folded configuration.

6. The foldable filter according to claim 1 wherein the foldable filter is packaged in a primary package and further packaged in secondary packaging.

7. An air purifier comprising a housing, a motor which is operated by a power source, an air displacement means, an air inlet and an air outlet and a removable and foldable filter according to claim 1.

8. The foldable filter according to claim 6 wherein the secondary packaging is shrink wrap, paper or cardboard.
